(19) United States
(12) Patent Application Publication
(10) Pub. No.: US 2026/0010576 A1
(43) Pub. Date: Jan. 8, 2026

(54) ANALYTICS ENGINE(S) FOR INTEGRATING VIRTUAL ASSISTANT INTERACTIONS INTO WEB ANALYTIC SYSTEMS

(71) Applicant: Oracle International Corporation, Redwood City, CA (US)

(72) Inventors: Laurentiu Busuioc, Alameda, CA (US); Kishan Kumar Agrawal, Fremont, CA (US)

(21) Appl. No.: 18/765,503

(22) Filed: Jul. 8, 2024

(51) Int. Cl. G06F 16/957; G06F 16/953; G06F 40/30; H04L 67/02

(52) U.S. Cl. CPC G06F 16/957; G06F 16/953; G06F 40/30; H04L 67/02

(57) ABSTRACT

Various embodiments of the present technology generally relate to systems and methods for providing an analytics engine. In an aspect, a method may be provided that includes receiving, by an analytics engine, a user query from a client device via a virtual assistant application hosted by a web-based application, where the web-based application includes various user interface (UI) elements, each of which is assigned to a respective event tag. Responsive to receiving the user query, the analytics engine may determine a first event tag based on the user query, where the first event tag is associated with a first UI element on the web-based application. The analytics engine may tag the user query with the first event tag to associate the user query with the first UI element and transmit a first report including the first event tag to a web analytics system associated with the web-based application.

### TECHNICAL FIELD

Various embodiments of the present technology generally relate to virtual assistant applications (“VA applications”). More specifically, embodiments of the present technology relate to systems and methods for providing analytics engine(s) for integrating interactions with VA applications into web analytic systems.

### BACKGROUND

In today's digital landscape, where businesses increasingly operate through web-based applications, web analytics play a crucial role in understanding and optimizing user engagement and operational efficiency. These analytics tools are pivotal for businesses as they provide valuable insights into how users interact with their web applications. By tracking metrics such as page views, session durations, click-through rates, and conversion paths, web analytics enable organizations to gauge the effectiveness of their online presence and marketing strategies. This data-driven approach empowers businesses to make informed decisions, improve user experience, and tailor content to meet customer needs more effectively. Essentially, web analytics serve as a compass, guiding businesses in navigating the complexities of the digital realm by offering actionable data that drives growth and enhances overall performance.

Complementing the insights gained from web analytics, organizations have increasingly turned to virtual assistant (VA) applications to enhance user interaction and support within their web-based platforms. These virtual assistants, powered by artificial intelligence (AI), such as natural language processing (NLP), provide users with personalized guidance, real-time support, and seamless navigation through complex workflows. By integrating virtual assistants into web applications, businesses can automate customer service inquiries, streamline user onboarding processes, and offer proactive assistance to resolve issues promptly. This trend not only improves user satisfaction by providing immediate responses and personalized recommendations but also frees up human resources to focus on more complex tasks, thereby boosting operational efficiency. As virtual assistant technologies continue to evolve, their role in enhancing the user experience and driving engagement across web applications is becoming increasingly indispensable for forward-thinking organizations. Together, web analytics and virtual assistants form a powerful duo, empowering businesses to create more intuitive, efficient, and user-centric digital experiences.

To further enhance user experience, organizations are increasingly leveraging virtual assistant analytic systems, to gain deep insights into user interactions with virtual assistants. While VA applications leverage analytic systems to track user interactions, these systems differ significantly from traditional web analytics. VA analytics focus more on understanding conversational data and user intents rather than page views and clicks typical of web analytics. These systems employ advanced NLP algorithms to analyze dialogue flows, sentiment analysis, and user responses to refine the virtual assistant's responses and improve overall user satisfaction. Metrics tracked include successful task completions, user satisfaction ratings, and response accuracy rather than traditional web metrics like bounce rates or session durations. By capturing and analyzing these nuanced interactions, VA analytics enable organizations to optimize conversational experiences, tailor responses to user preferences, and continuously enhance the effectiveness of virtual assistants in delivering value to users. Thus, while both types of analytics aim to improve user experience, VA analytics are uniquely tailored to the intricacies of human-computer interaction within conversational interfaces.

Despite their potential, VA analytic systems and web analytic systems currently suffer from a significant drawback: they do not integrate seamlessly. This lack of integration means that businesses must manually merge the data from VA analytics with their web analytics, a time-consuming and labor-intensive process. The fragmented nature of these systems creates challenges in obtaining a unified view of user interactions, complicating efforts to gain comprehensive insights and make data-driven decisions. Consequently, the inefficiency and added workload of manual integration can hinder the ability of organizations to fully capitalize on the benefits these technologies offer, ultimately impacting their operational efficiency and effectiveness in enhancing user experiences.

Accordingly, there exists a need for analytics engine(s) that provide improved approaches and architectures for integrating VA applications interactions into web analytic systems. In particular, the analytics engine(s) provided herein provide more modular and decoupled architectures that offer greater flexibility and scalability for integrating user interactions with VA applications into existing web analytic systems.

The information provided in this section is presented as background information and serves only to assist in any understanding of the present disclosure. No determination has been made and no assertion is made as to whether any of the above might be applicable as prior art with regard to the present disclosure.

### Overview

Technology is disclosed herein for systems and techniques for providing an analytics engine and its related functions. In an aspect, an analytics engine may be provided as part of a virtual assistant application hosted by a web-based application. The web-based application may include a variety of user interface (UI) elements that a user can interact with. To track user interactions with various UI elements for analytic and reporting purposes, each of the UI elements may be assigned a respective event tag. As described in greater detail below, assignment of event tags may be performed by a backend system, such as by an organization, by a web analytics system configured to track user interactions with the web-based application, or by a third party.

When a user interacts with the virtual assistant application, such as by initiating a chat session with the virtual assistant or chatbot, the analytics engine may determine an event tag based on the user query. In some cases, the analytics engine may first determine a user intent based on the user query, and then determine the event tag based on the user intent. Once the event tag is identified, the analytics engine may tag the user query with the event tag and transmit a report containing the event tag, and in some cases the user query, to a web analytics system associated with the web-based application.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment illustrating a web-based application associated with an organization, according to an embodiment herein;

FIG. 2 illustrates an example operational environment including an analytics engine, according to an embodiment herein;

FIG. 3 illustrates an example operational environment for a conventional virtual assistant application system 300, according to an embodiment herein;

FIG. 4 illustrates an example operational environment for a chatbot application system including an interface engine, according to an embodiment herein;

FIG. 5 illustrates an example operational environment including a virtual assistant application containing an analytic engine, according to an embodiment herein;

FIG. 6 illustrates an example analytics engine process, according to an embodiment herein;

FIG. 7 illustrates an example microbot, according to an embodiment herein;

FIG. 8 provides an illustrative visual flow of tagging user queries, according to an embodiment herein;

FIG. 9 illustrates an example flow for a user-VA interaction that is tagged for analytic purposes, according to an embodiment herein; and

FIG. 10 shows an example computing device suitable for providing an analytics engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Monitoring and gathering information on user interactions with a web-based application is crucial for understanding and enhancing user experience. By tracking how users navigate and engage with various elements of the application, businesses can identify patterns, preferences, and pain points. This information allows organizations to make informed decisions about design improvements, feature updates, and content optimization. Moreover, comprehensive user interaction data helps in personalizing user journeys, increasing engagement, and boosting conversion rates. In essence, diligent monitoring of user interactions provides the foundational insights necessary for creating a more intuitive, efficient, and satisfying web experience, ultimately driving the success of the application.

Current approaches to gathering information on user interactions with web-based applications predominantly rely on web analytic systems. These systems meticulously track how users interact with various user interface (UI) elements and graphical components within the application. By monitoring clicks, scrolls, hover times, and navigation paths, these analytics tools provide detailed insights into user behavior. They capture data on which buttons are clicked, how forms are filled out, which pages are visited most frequently, and how long users spend on each section. This granular information helps businesses understand which features are most engaging, which areas may cause frustration, and where users might abandon their tasks. By focusing on these interactions, web analytic systems enable organizations to refine their UI/UX design, streamline workflows, and enhance overall user satisfaction.

As web-based applications increasingly incorporate virtual assistants to aid users, web analytic systems face significant challenges in efficiently and effectively capturing user interactions with these AI-driven tools. Unlike traditional UI elements, virtual assistants engage users through dynamic and conversational interfaces, often powered by complex algorithms and natural language processing. These interactions are more nuanced and context-dependent, involving voice commands, text inputs, and real-time responses. Traditional web analytics systems, designed to track static UI elements, struggle to capture the depth and fluidity of these interactions. This gap results in a lack of comprehensive data on how users are utilizing virtual assistants, hindering the ability to analyze their effectiveness, improve their functionality, and enhance user experience.

While virtual assistant analytic systems are designed to capture user interactions with virtual assistants, these systems operate independently of the web-based application's UI elements. This segregation means that interactions users have with the virtual assistant, such as voice commands or chat inputs, are not linked to their activities on the broader web application interface. As a result, businesses lack a holistic view of the user journey, missing the context of how virtual assistant interactions influence or are influenced by other UI elements. This disconnect can lead to incomplete data, making it difficult to identify and address usability issues, optimize user flows, or understand the full impact of the virtual assistant on user experience. Without integrating these data streams, organizations may struggle to create a seamless and cohesive user experience, ultimately limiting the potential benefits of both virtual assistants and traditional web analytics.

Under current approaches, organizations use web analytic systems to track user interactions with UI elements on the web-based application, while relying on VA analytic systems to monitor interactions with the virtual assistant. These two analytic systems operate independently, each generating separate results in different formats. Although it is possible to integrate the results from these separate systems, conventional methods require manual data merging, which is both time-intensive and resource-intensive. This manual integration involves aligning disparate data sets, reconciling different metrics, and ensuring consistency across platforms. The laborious nature of this process not only delays the availability of comprehensive insights but also increases the risk of errors and data inconsistencies. Consequently, businesses face significant challenges in obtaining a unified view of user behavior, impeding their ability to make timely and informed decisions that could enhance the overall user experience and operational efficiency.

To address at least the shortcomings of conventional approaches noted above, an example analytic engine is provided herein. As will be described in greater detail below, the analytic engine provided herein provides an integrated approach capable of capturing user interactions with a virtual assistant and identifying an event tag associated with a corresponding UI element. The analytics engine may then tag the user interaction with the event tag such that the user interaction with the virtual assistant (e.g., user query or question) is associated with the UI element. This tag, as well as the user interaction in some cases, may then be provided to the web analytic system where it is incorporated into the overall analysis of the web-based application.

By tagging user interactions with event tags associated with corresponding UI elements, the analytics engine can provide an integrated system for capturing user interactions with a web-based application, regardless of if the user interaction is made with respect to a specific UI element or made via a conversation with a virtual assistant. Such an integrated system can provide a comprehensive and cohesive view of the entire user journey, combining the detailed tracking of traditional UI interactions with the nuanced data from virtual assistant engagements. The unified approach provided by the analytics engine enables businesses to understand how users move between interacting with the virtual assistant and the web-based application's UI, revealing insights into user preferences, specific challenges or difficulties encountered, and behavior patterns. By allowing for enhanced data integration, the analytics engine streamlines the analysis process, reducing the time and resources required for manual data merging, and minimizing the risk of errors. With a holistic understanding of user interactions, organizations can more effectively optimize their web-based applications, improve user experience, personalize content, and streamline workflows. Ultimately, the analytics engine empowers businesses to make more informed, data-driven decisions, driving greater efficiency, engagement, and satisfaction across their digital platforms.

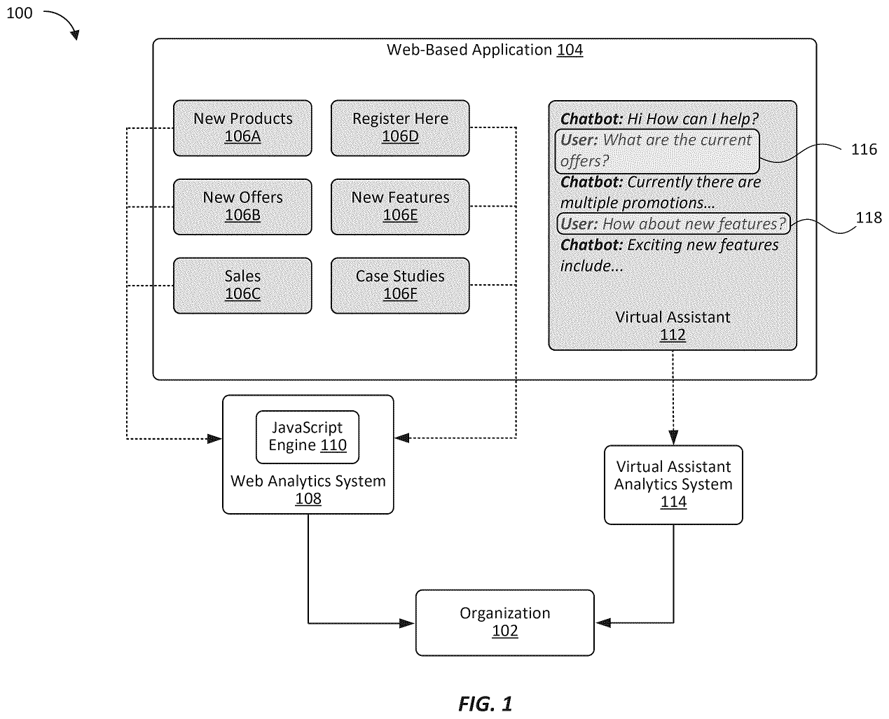

Turning now to FIG. 1, an example operational environment 100 illustrating a web-based application 104 associated with an organization 102 is provided, according to an embodiment herein. In this context, the organization 102 may represent a business utilizing the web-based application 104 as a platform to deliver goods and/or services to users. A web-based application 104 typically encompasses a range of graphical or user interface (UI) elements 106A-F. These elements serve as interactive components through which users navigate the application 104, allowing them to explore information about the organization 102 and its offerings of products or services. The UI elements 106A-F facilitate user engagement by providing interfaces for browsing, purchasing, customer support, and other functionalities essential to the user experience within the web-based application 104. It should be appreciated that while only UI elements 106A-F are illustrated and described herein, any number of UI elements 106A-F may be provided by the web-based application 104 and such UI elements may relate to providing any information to a respective user, not just the examples provided herein (e.g., product features and offers).

As shown, the operational environment 100 may include a web analytics system 108. In some embodiments, the web analytic system 108 may include a web analytics engine, such as a JavaScript engine 110. As those skilled in the art readily appreciate, the JavaScript engine 110 operates by embedding scripts directly into the web-based application's 104 codebase. These scripts capture and transmit data on user interactions with the UI elements 106A-F in real-time to the web analytics system 108. Specifically, the JavaScript analytics engine 110 tracks events like clicks, scrolls, form submissions, and page views initiated by users within the web-based application 104. By employing the web analytics system 108, the organization 102 can gather comprehensive insights into how users navigate, engage with content, and interact with various features of the web-based application 104. Specifically, the data collected by the JavaScript analytics engine 110 may be processed and analyzed to generate actionable metrics and reports. This enables the organization 102 to make informed decisions regarding UI improvements, content optimization, and strategic enhancements aimed at enhancing user experience and achieving business objectives effectively.

In addition to the web analytics system 108, the operational environment 100 may incorporate a virtual assistant 112 within the web-based application 104. In particular, the organization may deploy the virtual assistant 112 to enhance user interaction and support within the web-based application 104. As shown, the virtual assistant 112 may leverage artificial intelligence (AI), such as natural language processing (NLP) to respond to user queries 116 and 118, thereby enabling the virtual assistant 112 to provide personalized guidance, answer the queries 116 and 118 in real-time, and assist users through complex workflows. By integrating the virtual assistant 112 into the web-based application 104, the organization 102 may improve customer service efficiency, streamline user interactions, and offer proactive assistance, ultimately enhancing overall user satisfaction. Moreover, not only does the virtual assistant 112 reduce response times and enhances accessibility but the virtual assistant 112 also frees up human resources to focus on higher-level tasks, thereby optimizing operational efficiency of the web-based application 104.

The organization 102 may utilize a virtual assistant (VA) analytics system 114 to capture and analyze information on user interactions, such as the user queries 116 and 118, with the virtual assistant 112 as integrated within the web-based application 104. The VA analytics system 114 may operate by monitoring and processing data generated from user interactions with the virtual assistant 112. For example, the VA analytics system 114 may employ advanced AI algorithms, such as advanced NLP techniques to interpret conversational inputs, track user intents, and analyze the effectiveness of responses provided by the virtual assistant 112 to the user queries 116 and 118. By capturing metrics such as conversation duration, the user queries 116 and 118, response accuracy, and user satisfaction levels, the VA analytics system 114 provides insights into how effectively the virtual assistant 112 engages users and fulfills their needs. These insights enable the organization 102 to refine the virtual assistant's 112 capabilities, optimize its performance, and tailor its responses to better meet user expectations. Ultimately, the VA analytics system 114 may enhance the organization's 102 ability to deliver personalized and efficient user experiences through the web-based application 104, thereby improving overall user satisfaction and engagement.

As noted above the web analytics system 108 and the VA analytics system 114 operate independently within the operational environment 100, each generating distinct sets of results. The web analytics system 108 tracks metrics related to user interactions with UI elements 106A-F within the web-based application 104, such as clicks, page views, and navigation paths. Thus, the web analytics system 108 compiles data into structured reports that inform the organization 102 about user engagement patterns, content performance, and conversion rates. In contrast, the VA analytics system 114 focuses on analyzing interactions with the virtual assistant 112, capturing data on conversation flows, the user queries 116 and 118, response times, and user satisfaction metrics. Thus, even though the user queries 116 and 118 may correspond to content that is similar to the content of the UI elements 106B and 106E, the two systems are unable to identify this association.

Due to their independent operation, the web analytics system 108 and the VA analytics system 114 produce results in different formats and measure metrics specific to their respective functionalities, even when the context of each user interaction corresponds to the same subject matter. As shown, the organization 102 receives separate reports from each system, detailing insights relevant to web-based application's 104 usability and the virtual assistant's 112 performance. To derive comprehensive insights that merge data from both systems 108 and 114, the organization 102 must manually integrate the separate results or utilize them independently to inform strategic decisions. This process of integration involves aligning data streams, reconciling discrepancies, and synthesizing findings to gain a holistic understanding of user behavior across both UI interactions and the virtual assistant 112 engagements within the web-based application 104. As described above, managing separate results generated by the web analytics system 108 and the VA analytics system 114 imposes a burden on the organization 102, typically requiring manual integration effects that are time-consuming and resource-intensive if the organization 102 seeks a cohesive view of user interaction with the web-based application 104.

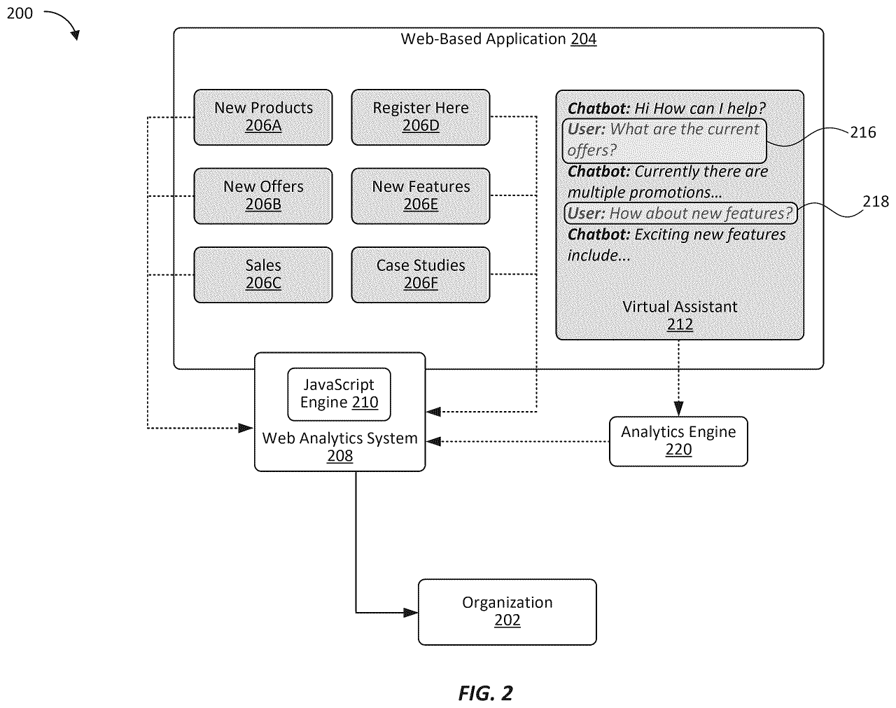

To address at least these issues with current web analytics systems 208, the organization 102 may employ an analytics engine, as provided herein. Referring now to FIG. 2, an example operational environment 200 including an analytics engine 220 is illustrated, according to an embodiment herein. As shown, the operational environment 200 may be the same or similar to the operational environment 100, such as including a web-based application 204 leveraged by an organization 202 as a platform to interact with users, which may be similar or the same as the web-based application 104 and the organization 102, respectively. As shown, the web-based application 204 includes UI elements 206A-F and a virtual assistant 212, which may be the same or similar to the UI elements 106A-F and the virtual assistant 112, respectively.

As shown, a user may interact with the virtual assistant 112 by submitting user queries 216 and 218. The user query 216, which may be similar to the user query 116, may be a request to learn more about new offers. The UI element 206B may also relate to new offers provided by the organization 202. As such, a user may learn more about the new offers by either selecting the new offers UI element 206B or by submitting the user query 216. The user query 218 may relate to new features of a respective service or good. Similarly, the UI element 206E may also relate to the new features of a respective service or good such that a user could learn similar information by selecting the UI element 206E or by submitting the user query 218.

As described above, under conventional approaches, despite the user queries 216 and 218 relating to the same content or subject matter as the UI elements 206B and 206E, respectively, the results from the web analytics system 208 and a respective virtual assistant analytics system, such as the VA analytics system 114, may not readily identify such a correlation. In contrast, however, the analytics engine 220, when leveraged by the organization 202, may readily detect and identify subject matter or content within the user queries 216 and 218 as corresponding to the UI elements 206B and 206E, respectively.

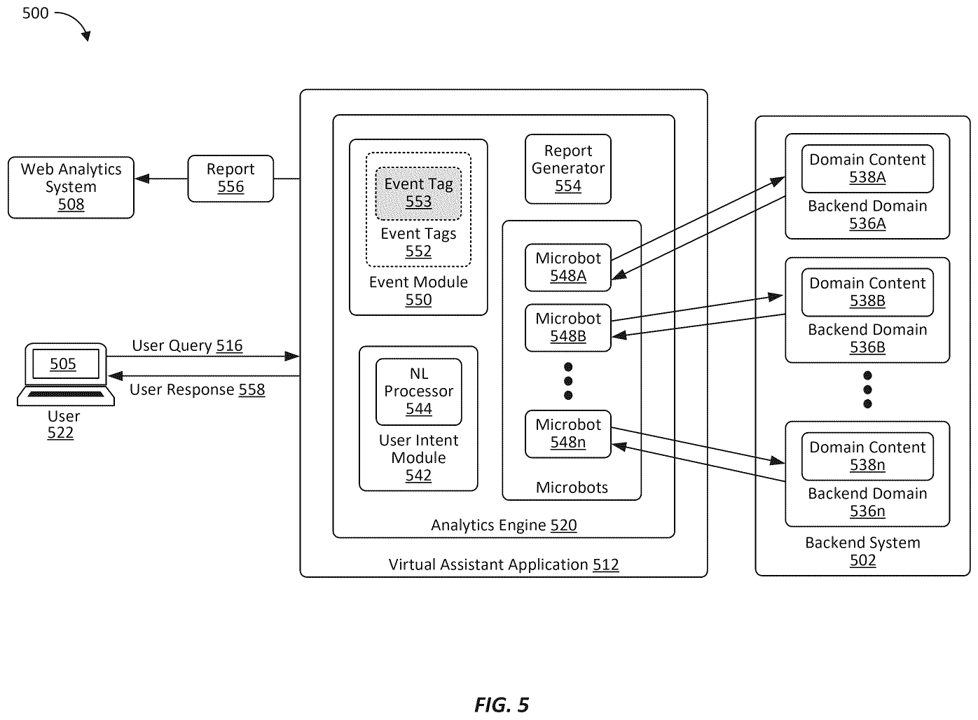

As will be described in greater detail below with respect to FIGS. 5-9, the analytics engine 220 may determine a user intent for each of the user queries 216 and 218, and from the user intent determine event tags for each of the user queries 216 and 218. The event tags may be the same as the event tags that the web analytics system 208, in particular a JavaScript engine 210 uses to track user interactions with the UI elements 206A-F. As such, each of the event tags may correspond to a different UI element, such as the UI elements 206B and 206E. Once the user queries 216 and 218 are tagged with the event tags, a report of each user query 216 and 218, along with the respective event tag, may be generated and provided by the analytics engine 220 to the web analytics system 208. Because the user queries 216 and 218, and in some cases the responses to the user queries 216 and 218, are tagged with the same event tags used by the JavaScript engine 210, when the web analytics system 208 receives the report from the analytics engine 220, the web analytics system 208 can readily analyze and generate reports that include both the user interactions with the UI elements 206A-F and the virtual assistant 212. As such, any results that the organization 202 receives from the web analytics system 208 includes information on user interactions with the UI elements 206A-F and the virtual assistant 212, providing a cohesive review of user interactions with the web-based application 204.

An obstacle that prevented conventional approaches from providing an analytics engine 220 and its related functions, as described herein, is the monolithic nature of conventional VA applications, such as the application that provides the virtual assistant 112. Generally, the VA analytics system 114 is part of the VA application, meaning that the report and analytics of any user interactions with the virtual assistant 112 are tied to the monolithic architecture of conventional systems. For example, virtual assistants are often delivered as Software as a Service (SaaS) and are typically leveraged through Platform as a Service (PaaS), meaning that the virtual assistant's specific structure and operational rules are hosted separately and managed independently from the organization.

One challenge caused by the conventional monolithic structure of virtual assistant applications involves how virtual assistant applications are insulated from the organizations utilizing them. This separation often leads to difficulties in reporting and analytics of user interactions with the virtual assistants. Since the virtual assistant's internal workings and data management are typically handled by external providers under a SaaS model, organizations may face limitations in accessing and integrating detailed interaction data into their own analytics systems. This lack of direct control and transparency can hinder the organization's ability to extract meaningful insights, track performance metrics effectively, and align virtual assistant usage with broader business goals. Furthermore, without seamless integration between virtual assistant analytics and reporting systems, such as the web analytics system 208, businesses may struggle to optimize user experiences, troubleshoot issues promptly, and leverage data-driven strategies to enhance overall operational efficiency and customer satisfaction.

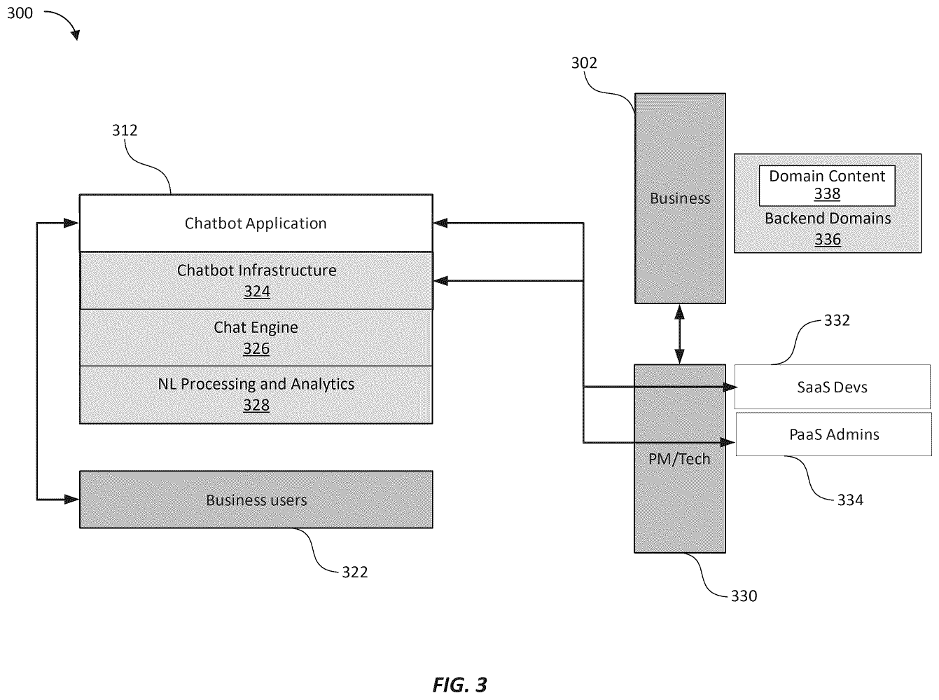

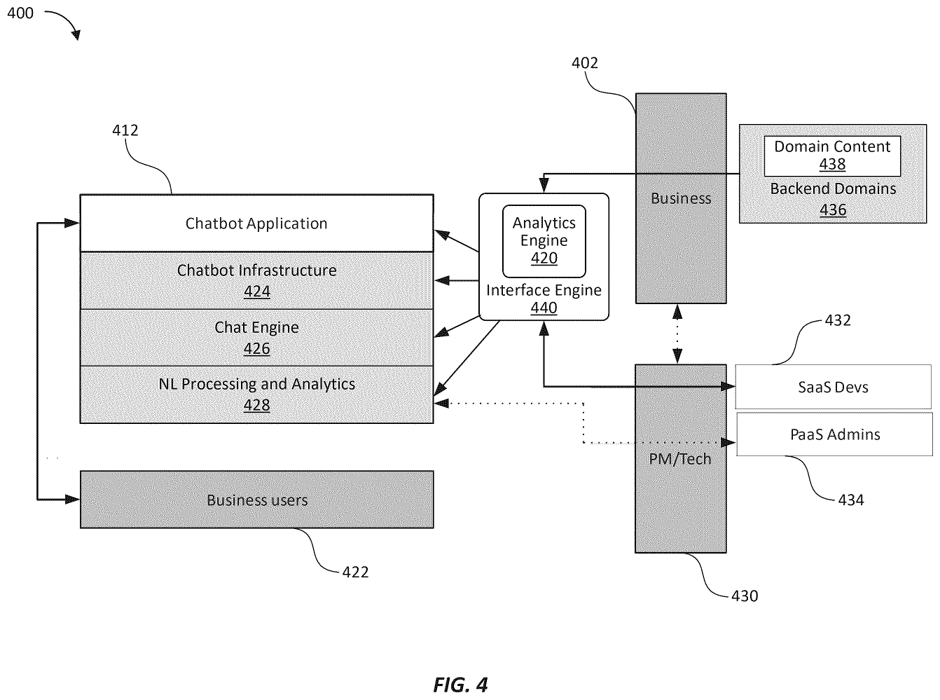

To aid in illustrating the impact of monolithic architecture on reporting and analytics of user interactions with virtual assistants, FIGS. 3 and 4 are provided. Referring to FIG. 3, an example operational environment for a conventional VA application system 300 (hereinafter “system 300”) is illustrated, according to an embodiment herein. FIG. 3 is provided to illustrate the challenges caused by the monolithic architecture of conventional VA applications, such as system 300. As shown, the system 300 includes a business 302 (e.g., backend system) that is part of an organization, such as the organization 102, and a chatbot application 312 (e.g., virtual assistant 112) that interacts with business users 322 of the business 302. For example, the business 302 may supply the chatbot application 312 to aid the business users 322 with various issues, such as provide immediate support for technical issues or a communication channel to direct users 322 to desired content or products.

As shown, the chatbot application 312 may include various components, such as a chatbot infrastructure 324, a chat engine 326, and a natural language processing and analytics component 328. The chatbot infrastructure 324 serves as the backbone of the chatbot application 312, orchestrating the administration, development of conversation flow design, and integration of API microservices seamlessly. At its core, the chat infrastructure 324 facilitates the creation and management of conversational experiences by enabling the design and deployment of dynamic conversation flows and management of APIs for the chatbot application 312. Through administration tools, developers, such as SaaS developers 332 described below, can effortlessly configure the behavior of the chatbot, fine-tuning its responses and adapting to evolving user needs.

The chat engine 326 may serve as the central nervous system of the chatbot application 312, seamlessly integrating chat servers to facilitate real-time communication while leveraging sophisticated natural language understanding algorithms to comprehend user input and generate appropriate responses. The natural language processing and analytics component 328 of the chatbot application 312 may include or be the VA analytics system 114, and as such analyze user inputs with advanced algorithms to accurately interpret intents and sentiments, while concurrently gathering valuable data insights to refine user experiences and optimize performance over time.

In the illustrated system 300, the chatbot application 312 is deployed on a Distributed Application Platform (DAP). As such, the system 300 includes a Project Management and Technical group 330 (hereinafter “group 330”) that aid in developing, deploying, and maintaining the chatbot application 312 on the DAP. In particular, the group 330 includes SaaS developers 332 and PaaS administrators 334. As those skilled in the art readily appreciate, the SaaS developers 332 and the PaaS administrators 334 play vital roles in maintaining the functionality and performance of the chatbot application 312, ensuring it remains updated and operational within the cloud computing ecosystem.

As part of the development and deployment of the chatbot application 312, the business 302 exports domain content 338 associated with various backend domains 336. For example, the business 302 may be a large organization containing numerous backend domains 336, such as human resources (HR), finance, retail, and technology. Each of these backend domains 336 may have its own domain content 338, such as one or more knowledge bases and workflows, and criteria that defines a successful chatbot-user interaction. As such, during the development and deployment of the chatbot application 312, the business 302 exports this domain content 338 to the group 330 for integration into chatbot application 312. In other words, the business 302 hands off its domain content 338 to the group 330 for integration into the chatbot application 312.

Additionally, each backend domain 320 may contain its own structure and rules relevant for analytics and reporting. For example, each backend domain 336 may have its own respective web-based application 106 or portion of the web-based application 106 via with users can interact with respective domain content 338. As such, different UI elements 106A-F may be created and provided via a respective web-based application 106, each of which corresponds to different domain content 338. Accordingly, as can be appreciated, different backend domains 336 and/or different domain content 338 may relate to different content or subject matter.

From the domain content 338, the SaaS developers 332 create the data training model and logic flow for the chatbot application 312 and the PaaS administrators 334 create the program logic, knowledge management training, and other facets of the chatbot application 312 that are configured to the organization's 102 standards. In particular, the SaaS developers 332 and the PaaS administrators 334 create and manage the functions of chatbot application 312, in particular the chatbot infrastructure 324, as described above. From there, the business users 322 interact with the chatbot application 312 as a SaaS application.

As can be appreciated, because the business 302 exports its domain content to the group 330 for integration into the chatbot application 312, the business 302 has minimal control or direct access to the domain content as managed by the SaaS developers 332 and the PaaS administrators 334. Since the domain content used to train the chatbot application 312 originates from the business 302 and is managed externally, any updates or modifications to this content, such as knowledge bases or workflows, require coordination with the SaaS developers 332 and PaaS administrators 334. As described above, these dependencies can lead to disruptions in the chatbot application 312 service of business users 322, thereby adversely affecting user experience and impeding efficient operational management.

Moreover, the insulation between the business 302 and the chatbot application 312 also complicates reporting and analytics of user interactions. For example, due to the insulation between the business 302 and the chatbot application 312 the business 302 may lack direct access to real-time data and insights generated by the chatbot application's 312 interactions with the users 322. For instance, if the chatbot application 312 encounters frequent user queries related to a new product feature or service issue, the business 302 may not immediately receive this feedback. Instead, they must rely on periodic reports or updates from the SaaS developers 332 and PaaS administrators 334, which can delay the identification and resolution of emerging issues. This lack of timely access to interaction data hampers the business's 302 ability to swiftly adjust strategies, refine responses, or address user concerns effectively, ultimately impacting customer satisfaction and operational efficiency.

To address the issues caused by the monolithic architecture of conventional virtual assistant applications, such as the virtual assistant 112, 212, and the chatbot application 312, an interface engine, such as the domain interface engine described in the related U.S. patent application Ser. No. 18/617,285 titled “DOMAIN INTERFACE ENGINE(S) FOR VIRTUAL ASSISTANT APPLICATIONS”, which is hereby incorporated by reference, may be leveraged.

Turning now to FIG. 4, an example operational environment for a chatbot application system 400 including an interface engine 440 is illustrated, according to an embodiment herein. As shown, the system 400 is similar to the system 300, such as including a business 402, a chatbot application 412, a group 430 including SaaS developers 432 and PaaS administrators 434, and business users 422. To develop and deploy the chatbot application 412, however, the system 400 includes the interface engine 440. As shown, the interface engine 440 provides an interface between the chatbot application 412 and the business 402 and the group 430, and may include an analytics engine 420

As described in U.S. patent application Ser. No. 18/617,285, the interface engine 440 communicates directly with the backend domains 436 of the business 402. By communicating directly with the backend domains 436, the interface engine 440 allows the architecture of the chatbot application 412 to be decoupled. That is, to develop, deploy, and maintain the chatbot application 412, the interface engine 440 interacts with the backend domains 436 to gain responses regarding various domain content 438, instead of requiring the business 402 to export the entirety of its backend domains 436 to the group 430. As can be appreciated, by limiting or foregoing the requirement of the business 402 to export its backend domains 436, the business 402 can continuously update, change, or maintain its domain content 438 without needing to coordinate with the group 430 to incorporate those changes into the chatbot application infrastructure 424.

The interface engine 440 may be coded by SaaS developers 432, either as an external component running outside of the monolith or as a plug-in library at the monolith level. As those skilled in the art readily appreciate, the SaaS developers 432 code consumers for the APIs exposed at the chatbot infrastructure 424 for interacting with the chat engine 426 and the NL processing and analytics 428. The APIs exposed at the chat engine 426 may allow the interface engine 440 to send answers directly downstream to the chatbot application 412. The APIs exposed at the NL processing and analytics 428 may allow the interface engine 440 to get NL results and allow the interface engine 440 to interact with the analytics portion of the NL processing and analytics component 428.

Because the interface engine 440 provides the necessary information to the chatbot infrastructure 424, chat engine 426, and NL processing and analytics component 428, the PaaS administrators' 434 interaction with the chatbot application 412 is reduced to providing content for the NL processing and analytics component 428. For example, in the decoupled approach provided by the interface engine 440, the PaaS administrators 434 may provide maintenance and fine tuning for the NL processing when required. PaaS administrators 434 may also collect and aggregate PaaS built-in analytics via the interface engine 440 for use as key performance indicators. PaaS administrators 434 ensure that the APIs retrieved at chatbot infrastructure 424 for the chat engine 426 and the NL processing and analytics component 428 are accessible and compliant with the PaaS compliance frameworks policies for the interface engine 440 on an ongoing basis.

As noted above, the interface engine 440 may include the analytics engine 420, which may be the same or similar to the analytics engine 220. As will be described in greater detail below with respect to FIGS. 5-9, the analytics engine 420 may determine a respective backend domain 436 that contains domain content 438 relevant to a user query, such as the user query 216. Based on the user query 216, and in some cases, the domain content 438, the analytics engine 420 may determine a respective event tag for the user query. The analytics engine 420 may tag the user query and generate a report that can be exported or otherwise provided to a related web analytics system. Since the domain content 438 may be updated or changed, thereby meaning that any respective event tags associated with the domain content 438 may change, by incorporating the analytics engine 420 into the interface engine 440, the analytics and reporting of user interactions with the chatbot application 412 can be decoupled from the group 430 and the business 402, while maintaining current and applicable structure, rules, and information.

Referring now to FIG. 5, an example operational environment 500 including a virtual assistant application, such as the chatbot application 412, containing an analytics engine 520 is provided, according to an embodiment herein. As shown, a user 522, which may be the same or similar to the business users 322 or 422 described above, interacts with a virtual assistant application 512 (“VA application 512”) via a client device 505. The VA application 512 may be the same or similar to the chatbot application 412.

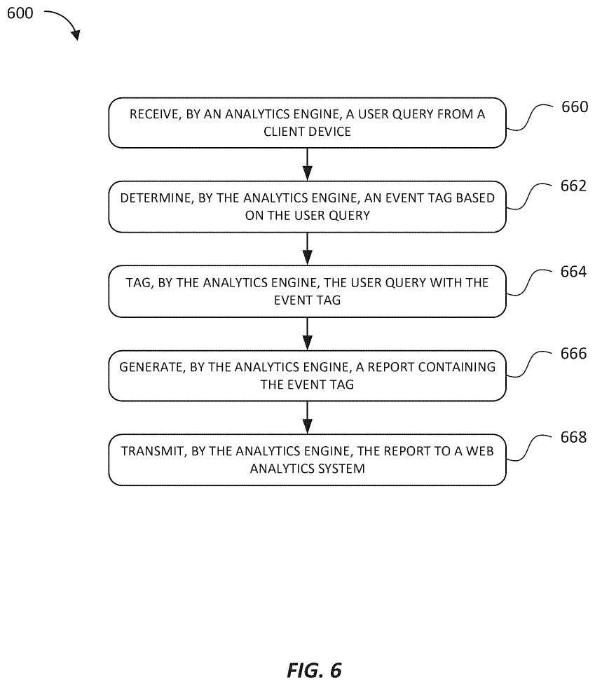

For ease of explanation, FIG. 5 is discussed in conjunction with FIGS. 6-9. Starting with FIG. 6, an example analytics engine process, in particular a process 600 for providing the analytics engine 520 and one or more of its functions, according to an embodiment herein. While FIG. 6 is described with relation to FIG. 5, it should be appreciated that components, elements, and steps from any other Figures described herein may be equally applicable.

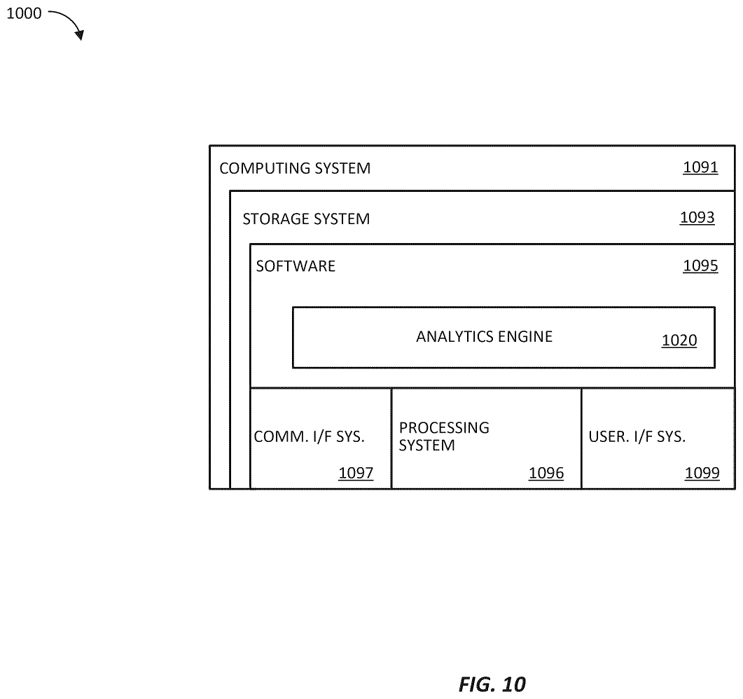

Broadly speaking, the client device 505 may access and interact with the VA application 512 in a cloud environment. For example, the client device 505 may communicate with the VA application 512 via one or more internets and intranets, the Internet, wired and wireless networks, local area networks (LANs), wide area networks (WANs), or any other type of network or combination thereof. Examples of the client device 505 may include personal computers, tablet computers, mobile phones, gaming consoles, wearable devices, Internet of Things (IoT) devices, and any other suitable devices, of which computing apparatus 1091 in FIG. 10 is also broadly representative.

In particular, the client device 505 may interact with the VA application 512 while visiting or interacting with a web-based application, such as the web-based application 204. The web-based application may be a platform leveraged by an organization associated with backend system 502, which may be similar to the backend system 436. As such, the web-based application may provide information related to domain content 538A-n, which may be the same or similar to the domain content 438A-n. Since the virtual assistant application 512 is hosted by the web-based application, the user 522 may submit user queries, such as the user query 516, containing content relating to the domain content 538A-n.

When the user 522 submits the user query 516, the analytics engine 520 may receive the user query 516 (660). Responsive to receiving the user query 516, the virtual assistant application 512, or in some cases the analytics engine 520, may determine an event tag 553 associated with the user query 516 (662). As noted above, the event tag 553 may be associated with a UI element of the web-based application, such as the UI element 206B. As will be expanded on in greater detail below, in some embodiments, the event tags 552 may be assigned to respective UI elements of the web-based application by a web analytics system 508, which may be the same or similar to the web analytics system 208. However, in other embodiments, the event tags 552 may be assigned to respective UI elements by the backend system 502.

In scenarios where the event tags 552 are assigned by the web analytics system 508, the analytics engine 520, during configuration or at points thereafter, may query the web analytics system 508 for the event tags 552 associated with the web-based application. However, as noted above, the organization, such as the backend system 502, may update information and content provided by the web-based application. As such, it may be more advantageous for event tags 552 to be provided via a respective backend domain 536A-n. For example, as the backend system 502 updates the domain content 538A-n associated with various UI elements provided on the web-based application, the analytics engine 520 can determine updated or most relevant event tags 552 for user queries.

To allow for the analytics engine 520, as well as user responses 558 generated by the virtual assistant application 512 to access accurate and up-to-date domain content 538A-n, the VA application 512 may have a decoupled architecture, as described herein. For example, the VA application 512 may include an interface engine, such as the interface engine 440, that includes infrastructure and systems to directly communicate with the backend system 502 to determine domain content 538A-n relevant to the user query 516. In the illustrated example, the VA application 512 also includes the analytics engine 520. In some embodiments, the analytics engine 520 may be part of the interface engine, while in other embodiments the analytics engine 520 may be separate from the interface engine. Additionally, although the analytics engine 520 is illustrated as part of the virtual assistant application 512, it should be appreciated that in some cases the analytics engine 520 may be hosted separately or remotely from the virtual assistant application 512, such as by a third party. Depending on the arrangement, the analytics engine 520 may be or incorporated into a message-based model that supports or is part of an underlying framework for communication between the VA application 512 and the client device 505. For example, when the user 522 sends a message, such as the user query 516, to the VA application 512, via the client device 505, the message is treated as a discrete unit of information and that discrete unit of information may be fed to the analytics engine 520.

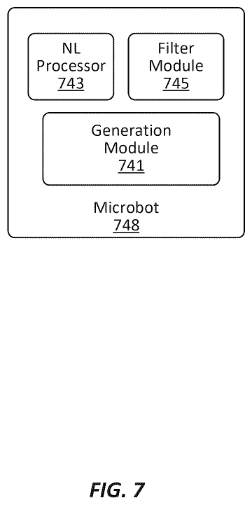

To decouple the VA application 512, the analytics engine 520 includes microbots 548A-548n. It should be appreciated that while only three microbots 548A-548n are illustrated, the analytics engine 520 may include any number of microbots 548A-548n. Each of the microbots 548A-548n may be a modular set of components configured to perform various functions. As will be described in greater detail below with respect to FIG. 7, each microbot may include a natural language (NL) processor, a filter module, a generator, and/or a validation module.

Each microbot 548A-548n may be assigned to a respective backend domain 536A-536n associated with backend system 502. The backend system 502 may be a business, such as business 402. As noted above, the backend system 502 may include multiple backend domains 536A-536n, such as human resources, finance, operations, research, or marketing. As can be appreciated, the type and number of backend domains 536A-536n that the backend system 502 contains depends on the type of business or organization that the backend system 502 operates.

Each backend domain 536A-536n includes domain content 538A-538n. Domain content 538A-538n includes information associated with its respective backend domain 536A-536n that the VA application 512 uses to interact with the user 522, such as knowledge bases, workflows, and criteria for when a VA-user interaction is successful. It should be appreciated, that while each backend domain 536A-536n includes a single domain content 538A-538n, that a backend domain may include more than one domain content, such as multiple knowledge bases. Similarly, while the following illustration discusses each microbot 548A-548n being assigned to a respective backend domain 548A-548n, that in some cases, a microbot 548A-548n may be assigned to a respective domain content 538A-538n within a given backend domain. And in still another embodiment, a microbot 548A-548n may be assigned to a specific area or segment or portion of domain content 538A-538n.

Each of the microbots 548A-548n may be assigned to a respective backend domain 536A-536n (or domain content 538A-538n) during a set-up or configuration process of the VA application 512 or the analytics engine 520. For example, during a configuration process of the analytics engine 520, a hosting organization may identify and assign each backend domain 536A-536n (or domain content 538A-538n) to a respective microbot 548A-548n. As can be appreciated, each backend domain 536A-536n (or domain content 538A-538n) may be distributed or spread between each of the microbot 548A-548n such that each microbot covers a different backend domain 536A-536n (or domain content 538A-538n).

It should be appreciated that while the microbots 548A-548n are illustrated as part of the analytics engine 520, in some embodiments the microbots 548A-548n may be separate from the analytics engine 520. For example, the microbots 548A-548n may be part of the interface engine 440. In such cases, the analytics engine 520 may be in operable communication with one or more of the microbots 548A-548n to perform the functions described herein.

As noted above, when the analytics engine 520 receives or otherwise identifies the user query 516 as received by the VA application 512, the analytics engine 520 may determine an event tag based on the user query 516 (662). To determine the event tag based on the user query 516, the analytics engine 520 may determine a user intent for the user query 516. For example, if the user query 516 includes a request for technical support, the analytics engine 520 may determine that the user intent of the user query 516 is to gain assistance from the VA application 512.

As part of the user intent, the analytics engine 520 may also determine which backend domain 536A-536n is applicable or most likely to contain relevant information for resolving the user query 516. For example, if the user query 516 involves a request on the lead time or availability of a product, then the analytics engine 520 may determine which backend domain 536A-536n contains or corresponds to the particular product or product inventory. However, if the user query 516 involves a request on the current job opportunities, then the analytics engine 520 may determine that a different backend domain 536A-536n is associated or contains information relating to pursuing careers at the backend system 502.

To determine the user intent from the user query 516, the analytics engine 520 may include a user intent module 542. The user intent module 542 may include a NL processor 544. As those skilled in the art may readily appreciate, the NL processor 544 may include a NL model and may parse the user query 516 by analyzing the syntactic and semantic structure of the query 516, identifying keywords, entities, and contextual cues to determine the user's intent. In some cases, the user intent module 542 may be separate from the analytics engine 520.

Upon receipt of the user query 516, the analytics engine 520 may determine a microbot from the microbots 548A-548n for handling the user query 516. For example, the analytics engine 520, or in some cases an interface engine, may select the microbot 548A for handling the user query 516. The analytics engine 520 may select the microbot 548A for handling the user query 516 based on the microbot 548A being assigned to the backend domain 536A or the microbot 548A being assigned to the domain content 538A. In other words, the analytics engine 520 may determine that the microbot 548A is assigned to or otherwise corresponds to the domain 536A. Since the user query 516 involves the domain content 538A, the analytics engine 520 may select the microbot 548A for handling the user query 516. In some cases, the analytics engine 520 may select the microbot 548A for handling the user query 516 based on the user intent determined by the user intent module 542. Once selected, the analytics engine 520 may transmit or otherwise indicate to the microbot 548A that it is to handle the user query 516.

When the microbot 548A receives the user query 516, the microbot 548A may retrieve the domain content 538A from the backend domain 536A. In particular, the microbot 548A may receive a domain response from the backend domain 536A that includes domain content 538A relevant to the user query 516. In some embodiments, along with identifying the domain response from the backend domain 536A, the microbot 548A may determine relevant event tags 552 based on the respective user query 516. For example, if the user query 516 involves a question about new offers or promotions for a specific product, then the microbot 548A may determine that the domain content 538A contains the relevant information for the specific product, and in some cases, new offers or promotions for the specific product. As such, when the microbot 548A retrieves the domain response from the backend domain 536A, the microbot 548A may also retrieve event tags 552 associated with the domain content 538A. In some embodiment, the microbot 548A may retrieve the event tags 552 associated with the domain content 538A, such as a list or chart of event tags 552 associated with different content or subject matter within the domain content 538A, while in other embodiments, the microbot 548A may only retrieve an event tag associated with the domain response.

To retrieve the domain content 538A and, in some embodiments, one or more event tags 552 associated with the domain content 538A, from the backend domain 536A, the microbot 548A may include various components. Referring now to FIG. 7, an example microbot 748 is illustrated, according to an embodiment herein. The microbot 748 may be the same or similar to the microbots 548A-548n. For ease of discussion, the microbot 748 is used interchangeably with the microbot 548A. The microbot 748 may include various components, including a generation module 741, a NL processor 743, a filter module 745, and a validation module (not shown). As can be appreciated, the microbot 748 may include all or only a subset of these components, as well as additional components.

To retrieve relevant domain content 538A and in some cases, relevant event tag(s) 552, the microbot 748 may generate a domain request based on the user query 516. In some cases, the domain request may include the user intent and user data associated with the user 522. In particular, the generation module 741 of the microbot 548A may generate the domain request based on the user query 516. In an example, the generation module 741 may include a content generator, such as a generative AI or machine learning (NL) model, for generating the domain request based on the user query 516. In embodiments where the microbot 748 retrieves the relevant event tag 553, the domain request generated by the generation module 741 may also request the relevant event tag 553 based on the user query 516.

As described above, since the microbot 748 is assigned to a respective backend domain, here, 536A, containing the domain content 538A, the generation module 741 may be trained on the domain content 538A. As such, the microbot 748 is tailored to the characteristics and nuances present in the domain content 538A, as well as the user queries 516 directed to the domain content 538A. As such, the microbot 748 achieves domain specificity and is able to accurately navigate or direct the user query 516 to an appropriate domain content 538A, thereby providing an accurate user response 558 and identification of a correct event tag 553.

In addition to improved response accuracy, the training time for the microbot 748 is significantly reduced over conventional VA application approaches due to the limited dataset size of the domain content 538A on which the microbot 748 is trained. As such, the microbot 748 provides a more resource-efficient approach to hosting a VA application.

In some cases, prior to generating a domain request based on the user query 516, the microbot 748 may filter the user query 516 to remove restricted content. Restricted content may include content that is irrelevant to answering the user query 516. For example, restricted content may include abusive or obscene language, personally identifiable information (PII), or content that the VA application 512 is not permitted to respond to. Content that the VA application 512 is prohibited from responding to may include competitive market questions (e.g., why is competitor X a better product) or information that is internal to the organization (e.g., financial data or internal policies or procedures).

To identify the restricted content from the user query 516, the microbot 748 may include the NL processor 743. In other words, the user query 516, upon receipt by the microbot 748, may be processed by the NL processor 743 to identify restricted content. If the microbot 748 identifies restricted content in the user query 516, the microbot 748 may generate and send a redirecting response to the client device 505, depending on the restricted content. For example, if the microbot 748 determines that the user query 516 is directed to requesting financial data about the organization, then the microbot 748 may send the redirecting response to the user 522 informing the user 522 that the VA application 512 cannot answer the user query 516. If, however, the restricted content only contains PII, then the microbot 748, in particular the filter module 745, may filter out the restricted content from the user query 516 and generate the domain request from the filtered user query 516.

In some cases, the filter module 745 may also determine whether the user query 516 is directed to an inapplicable domain and return a redirecting response if it is. An inapplicable domain may be a backend domain that is not included in the backend domains 536A-536n. For example, if the VA application 512 is a customer support chatbot that is meant to aid users, such as the user 522, with technical support on various products, but the user query 516 involves a question on how to apply to a job posting, then the filter module 745 may determine that the user query 516 is directed to an inapplicable domain. In some cases, an inapplicable domain may be a backend domain that is related to the backend system 502 but is not included in the backend domains 536A-536n associated with the VA application 512. When the microbot 748 determines that the user query 516 is directed to an inapplicable domain, microbot 748 may generate, via the generation module 741, a redirecting response that includes information, such as a link, associated with the inapplicable domain. Following the above example, the microbot 748 may generate a redirecting response that includes a link to a job posting or a VA application that handles job applications for the organization.

In such cases, when the microbot 748 generates the redirecting response that includes information associated with the inapplicable domain, the microbot 748 may determine an event tag 553 associated with the inapplicable domain. Following the above example, if the inapplicable domain relates to a job posting and a link to a career page on the web-based application, then the microbot 748 may determine an event tag 553 for the career page or job posting. To determine such an event tag 553, the microbot 748 may query the event module 550 that is part of the analytics engine 520. In some cases, the event module 550 may store a listing of event tags 552 associated with various content or subject matter associated with the web-based application. As such, in cases where the microbot 748 does not retrieve domain content from the backend system 502, such as in the case of a redirecting response, the microbot 748 may determine a relevant event tag 553 from the event module 550. As can be appreciated, because the event tags 552 stored within the event module 550 are not retrieved from the backend system 502, such event tags 552 may not be as up-to-date or current as event tags 552 retrieved from the backend system 502 from the microbot 748.

As described above, the microbot 748 retrieves the domain content 538A, and in some cases a relevant event tag 553, that is associated with the user query 516 from the backend domain 536A. Upon receipt of the domain content 538A and event tag 553 from the backend domain 536A, the microbot 748 may generate a user response 558 based on the domain content 538A. The analytics engine 520, via the VA application 512, then transmits the user response 558 to the client device 505.

Additionally, responsive to receiving the event tag 553 from the backend domain 536A, the analytics engine 520 may tag the user query 516 with the retrieved event tag 553 (664). As noted above, in some embodiments the event tag 553 may not be retrieved by the microbot 548 from the backend system 502, but instead received from the web analytics system 508. For example, when the web analytics system 508 is configured based on the web-based application, such as the web-based application 204, a listing or chart of the event tags 552 and their respective UI elements may be provided to the analytics engine 520. In such cases, the analytics engine 520 may store the event tags 552 associated with the web-based application, such as part of the event module 550. When the user query 516 is received and the user intent identified by the user intent module 542, the analytics engine 520 may query the event module 550 to determine a respective event tag 553 from the event tags 552.

Once the respective event tag 553 is identified by the analytics engine 520, the analytics engine 520 may tag the user query 516, and in some embodiments, the user response 558, with the event tag 553. In particular, the event module 550 may tag the user query 516 with the event tag 553. By tagging user query 516 with the event tag 553, the user query 516 is associated with the respective UI element, for example the UI element 206A. Because the UI element is associated with the same content or subject matter that the analytics engine 520 determines the user query 516 to be directed to, and the event tag 553 is associated with the UI element, tagging the user query 516 with the event tag 553 associates the user query 516 with the respective UI element, thereby enabling detailed tracking and analysis of the user interactions.

Tagging the user query 516 may involve identifying metadata, such as the timestamp, user ID, query content, and contextual information (e.g., the user's location or device type) from the user query 516. The event tag 553, which is often in the form of a unique identifier or a predefined label that categorizes the type of event (e.g., “offers”, “features”, “purchase”), may be incorporated or otherwise associated with the metadata. In an example, the metadata and event tag 553 may be processed into a structured format and provided to the web analytics system 508. In some cases, the event module 550 may store the metadata and event tag 553 to enable efficient querying and reporting. This allows analysts to filter and segment data based on specific events, facilitating insights into user behavior and the effectiveness of various interactions within the application.

To enable efficient analysis and reporting of the user query 516 and the event tag 553, the analytics engine 520 may generate a report containing the event tag 553 (666). For example, the analytics engine 520 may include a report generator 554 that may generate a report 556 of the event tag 553. In some cases, the report 556 may include the metadata associated with the user query 516 and/or the user response 558, along with the event tags 553. Once the report 556 is generated, the analytics engine 520 may provide the report 556 to the web analytics system 508 (668). As can be appreciated, by including the user query 516 and, in some cases, the user response 558, along with the event tag 553, the web analytics system 508 can identify content or subject matter corresponding to UI elements exchanged between the user 522 and the VA application 512. Including the content of the user query 516 and/or user response 558 may provide additional insight into the user experience with the web-based application.

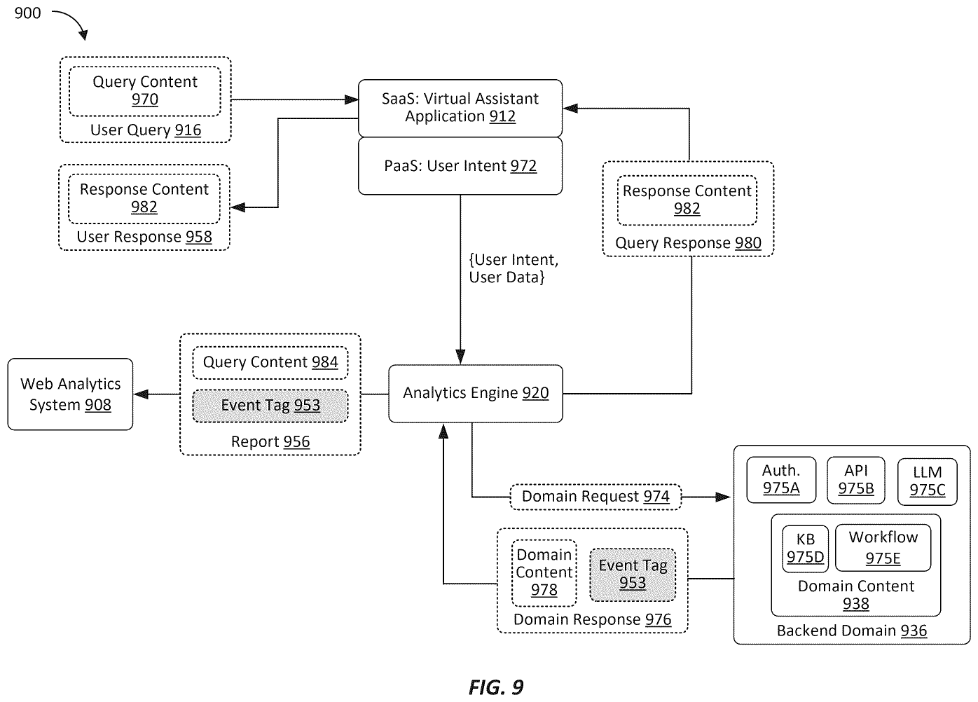

To provide one or more of the functions described above, the analytics engine 520 may employ one or more server computers (not shown) co-located with respect to each other or distributed across one or more data centers, of which computing apparatus 1091 in FIG. 9 is broadly representative. In some embodiments, the analytics engine 520, along with its various components, may be hosted on the same servers or infrastructure as the VA application 512, while in other embodiments, the analytics engine 520 may be hosted separately, such as by a third party. Various configurations are contemplated herein.

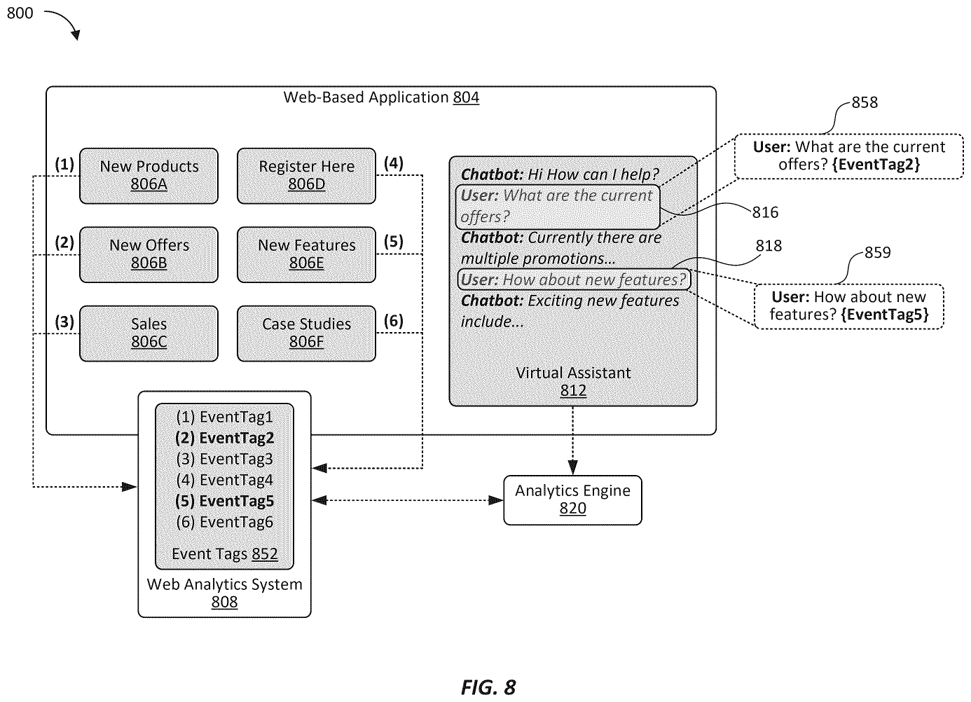

Referring now to FIG. 8, an illustrative visual flow 800 of tagging user queries is provided, according to an embodiment herein. As shown, a web-based application 804, which may be the same or similar to the web-based application 204 may be provided to a user, such as the user 522 via a client device, such as the client device 505. The user may interact with the web-based application 804 via one or more UI elements 806A-F, which may be the same or similar to the UI elements 206A-F. Additionally, the web-based application 804 may include a virtual assistant 812 which may be provided by a VA application, such as the VA application 512. During his or her interaction with the web-based application 804, the user may exchange messages with the virtual assistant 812. For example, as illustrated, the user may submit a user query 816 requesting information on current offers and a user query 818 requesting information about new features.

The virtual assistant 812 may be in operable communication with an analytics engine 820, which may be the same or similar to the analytics engine 520. For example, the virtual assistant 812 may be hosted by the VA application 512 which may include the analytics engine 820. As such, when the user submits the user queries 816 and 818 to the virtual assistant 812, the analytics engine 820 may receive the user queries 816 and 818 or the metadata associated with the user queries 816 and 818. Responsive to receiving the user queries 816 and 818, the analytics engine 820 may determine a relevant event tag for each of the user queries. As described above, this may include determining a user intent based on the respective user query. Based on the user intent, the analytics engine 820 may determine a relevant event tag.

A web analytics system 808 may be associated with the web-based application 804. In the illustrated example, the web analytics system 808 may define event tags 852 associated with the UI elements 806A-F. As described above, each of the event tags 852 may be associated or assigned to a respective UI element 806A-F. For example, an EventTag1 is associated with the UI element 806A, an EventTag2 is associated with the UI element 806B, an EventTag3 is associated with the UI element 806C, an EventTag4 is associated with the UI element 806D, an EventTag5 is associated with the UI element 806E, and an EventTag6 is associated with the UI element 806F. Based on the user intent associated with each user query 816 and 818, the analytics engine 820 may determine that the EventTag2 is relevant to the user query 816 and the EventTag5 is relevant to the user query 818.

Once the EventTag2 and EventTag5 are identified by the analytics engine 820, the analytics engine 820 may tag each respective user query 816 and 818. As noted above, this may include tagging or otherwise associating the metadata for each user query 816 and 818 with the unique identifier of the respective event tag. In the cases where the user response, such as the user response 558 is tagged as well, the analytics engine 820 may tag the user response or metadata associated with the response as well.

The analytics engine 820 may then generate a report recording the tagging of the user queries 816 and 818. For example, the analytics engine 820 may generate a report 858 for the user query 816 that includes the EventTag2 and a report 859 for the user query 818 that includes the EventTag5. Although the current illustration shows that the reports 858 and 859 include the content of the user queries 816 and 818, respectively, in some embodiments, only portions of the metadata associated with each user query may be included in the report. For example, in some cases, only a timestamp for each of the user queries 816 and 818 may be included in the report 858 and 859.

Once generated, the reports 858 and 859 may be provided to the web analytics system 808. In some cases, each report 858 and 859 may be transmitted to the web analytics system 808 upon generation, meaning that the report 858 may be transmitted first to the web analytics system 808, followed by the report 859. In this manner, the web analytics system 808 can receive real-time information on user interactions with the virtual assistant 812. In other cases, the analytics engine 820 may generate a single report or results from the virtual assistant exchange that is provided to the web analytics system 808 upon completion of the exchange. That is, once the user completes his or her communication with the virtual assistant 812, such as closing out the virtual assistant 812 prompt panel or the session times out, the analytics engine 820 may generate a single report containing the reports 858 and 859 and provide it to the web analytics system 808 at that time.

Referring now to FIG. 9, an example flow 900 for a user-VA interaction that is tagged for analytic purposes is illustrated, according to an embodiment herein. As illustrated, a virtual assistant application 912 (“VA application 912”), which may be the same or similar to the VA application 512, receives a user query 916. The user query 916 may be received from a user via a client device, such as the user 522 via the client device 505. The user query 916 may include query content 970, such as message or text containing a question for the VA application 912. The query content 970 may also include user data. In some cases, as part of the message exchange process, the VA application 912 may request information from the user or may link the user with an associated user profile. In other cases, the user may include information, such as a username, phone number, email address, or other PII.

Upon receipt of the user query 916, the VA application 912 may determine a user intent 972 from the user query 916, as described above. In the illustrated example, the user intent 972 may be determined as part of the PaaS component of the VA application 912. For example, a PaaS component may integrate other AI services into the VA application 912, such as incorporating a ML API or NLP library into the VA application 912. As such, the user query 916 may be parsed by the AI service integrated by the PaaS component to determine the user intent 972.

Once the user intent 972 is determined the VA application 912 may provide the user intent 972 to an analytics engine 920. In some cases, the VA application 912 may also provide the user data and/or the user query 916 to the analytics engine 920. As can be appreciated, in some cases, the user intent 972 may contain the relevant information from the user query 916, and as such, the VA application 912 may not provide the user query 916 to the analytics engine 920. However, in cases where the analytics engine 920 determines the user intent 972, such as described above, then the user query 916 may be provided to the analytics engine 920.

From the user intent 972, and in some cases the user data, the analytics engine 920 may generate a domain request 974. The domain request 974 may include a prompt or request for a respective backend domain 936. The domain request 974 may include a request for a response to the user query 916 and, in some cases, a respective event tag. As described above, the analytics engine 920 includes multiple microbots, each of which is assigned to a respective backend domain. As such, a respective microbot may generate a domain request 974 to a respective backend domain, represented here as the backend domain 936.

The backend domain 936 may include a variety of components, such as an authorization module 975A, an API 975B, a large language model (LLM) 975C, and domain content 938. As described above, the domain content 938 may contain one or more knowledge bases 975D and one or more workflows 975E associated with the backend domain 936. When the domain request 974 is received, the authorization module 975A may authenticate the domain request 974 as a valid request and the API 975B may provide the analytics engine 920 with access to the various components of the backend domain 936. For example, the API 975B may coordinate or direct the domain request 974 to the LLM 975C. While the LLM 975C is illustrated in the flow 900, it should be appreciated that the backend domain 936 may include any variety of language processing systems, such as NLP, ML systems, or generative AI models.

The LLM 975C may receive the domain request 974 and generate a domain response 976 to the domain request 974. For example, the LLM 975C may receive the domain request 974 as a prompt and query the domain content 938 to retrieve relevant information form the knowledge base 975D and/or workflows 975E to provide the domain response 976. As such, the domain response 976 may include domain content 978 corresponding to the fetched domain content 938 from the backend domain 936. As can be appreciated, the domain response 976 may include a natural language response to the domain request 974, as well as the specific information pulled from the domain content 938 (e.g., the domain content 978). In addition to the domain content 978, the domain response 976 may also include a relevant event tag 953. For example, the LLM 975C may receive the domain request 974 and query the knowledge base 975D and/or workflows 975E to determine the event tag 953.

When the analytics engine 920 receives the domain response 976, the analytics engine 920 may validate the domain response 976 and generate a query response 980. The query response 980 may include response content 982, such as a message tailored to the user and the domain content 978 provided from the backend domain 936. As can be appreciated, the analytics engine 920 may have more context on the interaction between the user and the VA application 912 and as such may modify the domain response 976 received from the backend domain 936 such to fit into the context of the interaction.

Once the VA application 912 receives the query response 980, the VA application 912 transmits the query response 980 to the user as a user response 958. The user response 958 may be provided to the user via an interface such to indicate that the user response 958 is responsive to the submitted user query 916.

Simultaneously or sequentially to generation of the query response 980 and transmission of the user response 958 to the user, the analytics engine 920 may tag the user query 916, and in some cases the query response 980 with the event tag 953. Although this example involves the analytics engine 920 retrieving a respective event tag 953 from the backend domain 936, it should be appreciated that in some embodiments, the event tag 953 may be received or identified based on information provided by the web analytics system 908. As noted above, during configuration or a set-up process, the analytics engine 920 may receive event tags associated with the web-based application, in particular, UI elements that are provided as part of a UI of the web-based application.

Once the user query 916 is tagged with the event tag 953, the analytics engine 920 may generate a report 956. The report 956 may include the event tag 953 and in some cases, information associated with the user query 916. In the illustrated example, the report 956 includes query content 984 and the event tag 953. The report 956 may be provided to the web analytics system 908 for incorporation into its respective analytics and reporting procedures. As noted above, since the user query 916 is tagged with the event tag 953 that is associated with a respective UI element, the event tag 953 can be efficiently and easily incorporated into the web analytics system's 908 analysis of user interactions with the web-based application.

Referring now to FIG. 10, is a diagram of a system 1000 configured to implement an analytics engine, according to an embodiment herein. The system 1000 may be an example of an apparatus including a computing apparatus 1091 that is representative of any system or collection of systems in which the various processes, systems, programs, services, and scenarios disclosed herein may be implemented. For example, computing apparatus 1091 may be an example analytics engine, such as the analytics engine 520, a client device, such as the client device 505, or any of the subcomponents depicted in the operational environment 500 of FIG. 5 or viewable flow 800 of FIG. 8. Examples of computing apparatus 1091 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 1091 may be implemented as a single apparatus, system, or device or may be implemented in a distributed manner as multiple apparatuses, systems, or devices. Computing apparatus 1091 may include, but is not limited to, processing system 1096, storage system 1093, software 1095, communication interface system 1097, and user interface system 1099. Processing system 1096 may be operatively coupled with storage system 1093, communication interface system 1097, and user interface system 1099.

Processing system 1096 may load and execute software 1095 from storage system 1093. Software 1095 may include an analytics engine 1020, which may be representative of any of the operations for providing an analytics engine or any of its related functions, as discussed with respect to the preceding figures. When executed by processing system 1096, software 1095 may direct processing system 1096 to operate as described herein for at least the various processes, such as the process 600 or flows 800 and 900, operational scenarios, and sequences discussed in the foregoing implementations. Computing apparatus 1091 may optionally include additional devices, features, or functionality not discussed for purposes of brevity.

In some embodiments, processing system 1096 may comprise a micro-processor and other circuitry that retrieves and executes software 1095 from storage system 1093. Processing system 1096 may be implemented within a single processing device but may also be distributed across multiple processing devices or sub-systems that cooperate in executing program instructions. Examples of processing system 1096 may include general purpose central processing units, graphical processing units, application specific processors, and logic devices, as well as any other type of processing device, combinations, or variations thereof.

Storage system 1093 may comprise any memory device or computer-readable storage medium readable by processing system 1096 and capable of storing software 1095. Storage system 1093 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 1093 may also include computer readable communication media over which at least some of software 1095 may be communicated internally or externally. Storage system 1093 may be implemented as a single storage device but may also be implemented across multiple storage devices or sub-systems co-located or distributed relative to each other. Storage system 1093 may comprise additional elements, such as a controller, capable of communicating with processing system 1096 or possibly other systems.

Software 1095 (including the analytics engine 1020 among other functions) may be implemented in program instructions that may, when executed by processing system 1096, direct processing system 1096 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1095 may include additional processes, programs, or components, such as operating system software, virtualization software, or other application software. Software 1095 may also comprise firmware or some other form of machine-readable processing instructions executable by processing system 1096.

In general, software 1095 may, when loaded into processing system 1096 and executed, transform a suitable apparatus, system, or device (of which computing apparatus 1091 is representative) overall from a general-purpose computing system into a special-purpose computing system as described herein. Indeed, encoding software 1095 on storage system 1093 may transform the physical structure of storage system 1093. The specific transformation of the physical structure may depend on various factors in different implementations of this description. Examples of such factors may include, but are not limited to, the technology used to implement the storage media of storage system 1093 and whether the computer-storage media are characterized as primary or secondary storage, as well as other factors.

For example, if the computer-readable storage medium are implemented as semiconductor-based memory, software 1095 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1097 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 1091 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an analytics engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; an analytics engine comprising processor-executable instructions stored on the computer-readable storage medium; and one or more processors coupled to the computer-readable storage medium and configured to execute the processor-executable instructions, wherein the processor-executable instructions, when executed by the one or more processors, direct the computing apparatus, to at least: receive a user query from a client device via a virtual assistant application hosted by a web-based application, wherein the web-based application comprises a plurality of user interface (UI) elements; determine a first event tag based on the user query, wherein: each of the plurality of UI elements is assigned a respective event tag; and the first event tag is associated with a first UI element of the plurality of UI elements; tag the user query with the first event tag to associate the user query with the first UI element; and transmit, to a web analytics system associated with the web-based application, a first report comprising the first event tag.

Example 2 is the computing apparatus of any previous or subsequent Example, wherein the analytics engine comprises a natural language model and the processor-executable instructions to determine the first event tag based on the user query, when executed by the one or more processors, further direct the computing apparatus to: submit the user query to the natural language model; determine a user intent of the user query based on a response from the natural language model; and select the first event tag based on the user intent.

Example 3 is the computing apparatus of any previous or subsequent Example, wherein the processor-executable instructions to determine the first event tag based on the user query, when executed by the one or more processors, further direct the computing apparatus to: determine domain content based on the user query; determine a plurality of event tags associated with the domain content; and determine the first event tag from the plurality of event tags.

Example 4 is the computing apparatus of any previous or subsequent Example, wherein the processor-executable instructions, when executed by the one or more processors, further direct the computing apparatus to: determine a query response generated responsive to the user query; and associate the query response with the user query, wherein the first report transmitted to the web analytics system comprises the user query, the query response, and the first event tag.

Example 5 is the computing apparatus of any previous or subsequent Example, wherein the processor-executable instructions, when executed by the one or more processors, further direct the computing apparatus to: receive, from the web analytics system associated with the web-based application, a plurality of event tags, wherein the web analytics system defines each of the plurality of event tags as associated with a corresponding UI element of the plurality of UI elements.

Example 6 is the computing apparatus of any previous or subsequent Example, wherein the analytics engine comprises a plurality of microbots, wherein each of the plurality of microbots is associated with a respective backend domain within a plurality of backend domains, and the processor-executable instructions, when executed by the one or more processors, further direct the computing apparatus to: generate, by a first microbot of the plurality of microbots, a prompt based on the user query, wherein the prompt is configured to elicit a response from a first backend domain of the plurality of backend domains; transmit, by the first microbot, the prompt to the first backend domain; receive, by the first microbot, a domain response from the first backend domain; and determine, by the analytics engine, the first event tag based on the domain response.

Example 7 is the computing apparatus of any previous or subsequent Example, wherein the processor-executable instructions, when executed by the one or more processors, further direct the computing apparatus to: receive a second user query from the client device via the virtual assistant application; determine a second event tag based on the second user query, wherein the second event tag is associated with a second UI element of the plurality of UI elements; tag the second user query with the second event tag; and transmit, to the web analytics system, a second report comprising the second event tag, wherein the first report is transmitted to the web analytics system at a first time, the second report is transmitted to the web analytics system at a second time, and the second time is after the first time.

Example 8 is a method comprising: receiving, by an analytics engine, a user query from a client device via a virtual assistant application hosted by a web-based application, wherein the web-based application comprises a plurality of user interface (UI) elements; determining, by the analytics engine, a first event tag based on the user query, wherein: each of the plurality of UI elements is assigned a respective event tag; and the first event tag is associated with a first UI element of the plurality of UI elements; tagging, by the analytics engine, the user query with the first event tag to associate the user query with the first UI element; and transmitting, to a web analytics system associated with the web-based application, a first report comprising the first event tag.

Example 9 is the method of any previous or subsequent Example, wherein the analytics engine comprises a natural language model and determining, by the analytics engine, the first event tag based on the user query further comprises: determining, using the natural language model, a user intent based on the user query; and selecting, by the analytics engine, the first event tag based on the user intent.

Example 10 is the method of any previous or subsequent Example, wherein the method further comprises: receiving, by the analytics engine, a second user query from the client device via the virtual assistant application; determining, by the analytics engine, a second event tag based on the second user query, wherein the second event tag is associated with a second UI element of the plurality of UI elements; tagging, by the analytics engine, the second user query with the second event tag to associate the second user query with the second UI; and transmitting, to the web analytics system, a second report comprising the second event tag, wherein the first report is transmitted to the web analytics system at a first time, the second report is transmitted to the web analytics system at a second time, and the second time is after the first time.

Example 11 is the method of any previous or subsequent Example, wherein the first report comprises one or more of: a timestamp associated with the user query; the user query; or a query response generated by the virtual assistant application responsive to the user query.

Example 12 is the method of any previous or subsequent Example, wherein determining, by the analytics engine, the first event tag based on the user query comprising: determining, by the analytics engine, a query response generated responsive to the user query; and determining, by the analytics engine, the first event tag based on the query response.

Example 13 is the method of any previous or subsequent Example, wherein the analytics engine comprises a plurality of microbots, wherein each of the plurality of microbots is associated with a respective backend domain within a plurality of backend domains, and the method further comprises: generating, by a first microbot of the plurality of microbots, a prompt based on the user query and user data associated with the client device, wherein the prompt is configured to elicit a response from a first backend domain; transmitting, by the first microbot, the prompt to the first backend domain; receiving, by the first microbot, a domain response from the first backend domain; and determining, by the analytics engine, the first event tag based on the domain response.

Example 14 is the method of any previous or subsequent Example, wherein the analytics engine comprises a plurality of microbots, wherein each of the plurality of microbots is associated with a respective backend domain within a plurality of backend domains, and the method further comprises: determining, by the analytics engine, a user intent based on the user query; and selecting, by the analytics engine, a first microbot of the plurality of microbots for handling the user query based on the user intent.

Example 15 is a computer-readable storage medium comprising processor-executable instructions, wherein the processor-executable instructions comprise an analytics engine configured to cause one or more processors to: receive, from an analytics engine, a user query from a client device via a virtual assistant application hosted by a web-based application, wherein the web-based application comprises a plurality of user interface (UI) elements; determine, by the analytics engine, a first event tag based on the user query, wherein: each of the plurality of UI elements is assigned a respective event tag; and the first event tag is associated with a first UI element of the plurality of UI elements; tag, by the analytics engine, the user query with the first event tag associated with the first UI element; and generate, by the analytics engine, a report comprising the first event tag and the user query.

Example 16 is the computer-readable storage medium of any previous or subsequent Example, wherein the processor-executable instructions to determine, by the analytics engine, the first event tag based on the user query cause the one or more processors to further execute processor-executable instructions stored in the computer-readable storage medium to: determine, by the analytics engine, a user intent based on the user query; determine, by the analytics engine, that the user intent corresponds to the first UI element; and select, by the analytics engine, the first event tag based on the user intent corresponding to the first UI element.

Example 17 is the computer-readable storage medium of any previous or subsequent Example, wherein the processor-executable instructions cause the one or more processors to further execute processor-executable instructions stored in the computer-readable storage medium to: map, by the analytics engine, the user query to the first UI element of the plurality of UI elements based on the first event tag.

Example 18 is the computer-readable storage medium of any previous or subsequent Example, wherein the processor-executable instructions cause the one or more processors to further execute processor-executable instructions stored in the computer-readable storage medium to: receive, by the analytics engine, a second user query from the client device via the virtual assistant application; determine, by the analytics engine, a second event tag based on the second user query, wherein the second event tag is associated with a second UI element of the plurality of UI elements; tag, by the analytics engine, the second user query with the second event tag; and transmit, by the analytics engine, the report comprising the first event tag and the second event tag to a web analytics system associated with the web-based application.

Example 19 is the computer-readable storage medium of any previous or subsequent Example, wherein the analytics engine comprises a plurality of microbots, each of the plurality of microbots being associated with a respective backend domain within a plurality of backend domains, and the processor-executable instructions cause the one or more processors to further execute processor-executable instructions stored in the computer-readable storage medium to: generate, by a first microbot of the plurality of microbots, a prompt based on the user query, wherein the prompt is configured to elicit a response from a first backend domain; transmit, by the first microbot, the prompt to the first backend domain; receive, by the first microbot, a domain response from the first backend domain; and determine, by the analytics engine, the first event tag based on the domain response.

Example 20 is the computer-readable storage medium of any previous or subsequent Example, wherein the processor-executable instructions cause the one or more processors to further execute processor-executable instructions stored in the computer-readable storage medium to: provide, by the analytics engine, the report to a web analytics system associated with the web-based application, wherein the report generated by the analytics engine comprises one or more of: a timestamp associated with the user query; the user query; or a query response generated by the virtual assistant application responsive to the user query.

What is claimed is:

1. A computing apparatus comprising:
a computer-readable storage medium;
an analytics engine comprising processor-executable instructions stored on the computer-readable storage medium; and
one or more processors coupled to the computer-readable storage medium and configured to execute the processor-executable instructions, wherein the processor-executable instructions, when executed by the one or more processors, direct the computing apparatus, to at least:
receive a user query from a client device via a virtual assistant application hosted by a web-based application, wherein the web-based application comprises a plurality of user interface (UI) elements;
determine a first event tag based on the user query, wherein:
each of the plurality of UI elements is assigned a respective event tag; and
the first event tag is associated with a first UI element of the plurality of UI elements;
tag the user query with the first event tag to associate the user query with the first UI element; and
transmit, to a web analytics system associated with the web-based application, a first report comprising the first event tag.

2. The computing apparatus of claim 1, wherein the analytics engine comprises a natural language model and the processor-executable instructions to determine the first event tag based on the user query, when executed by the one or more processors, further direct the computing apparatus to:
submit the user query to the natural language model;
determine a user intent of the user query based on a response from the natural language model; and
select the first event tag based on the user intent.

3. The computing apparatus of claim 1, wherein the processor-executable instructions to determine the first event tag based on the user query, when executed by the one or more processors, further direct the computing apparatus to:
determine domain content based on the user query;
determine a plurality of event tags associated with the domain content; and
determine the first event tag from the plurality of event tags.

4. The computing apparatus of claim 1, wherein the processor-executable instructions, when executed by the one or more processors, further direct the computing apparatus to:
determine a query response generated responsive to the user query; and
associate the query response with the user query,
wherein the first report transmitted to the web analytics system comprises the user query, the query response, and the first event tag.

5. The computing apparatus of claim 1, wherein the processor-executable instructions, when executed by the one or more processors, further direct the computing apparatus to:
receive, from the web analytics system associated with the web-based application, a plurality of event tags, wherein the web analytics system defines each of the plurality of event tags as associated with a corresponding UI element of the plurality of UI elements.

6. The computing apparatus of claim 1, wherein the analytics engine comprises a plurality of microbots, wherein each of the plurality of microbots is associated with a respective backend domain within a plurality of backend domains, and the processor-executable instructions, when executed by the one or more processors, further direct the computing apparatus to:
generate, by a first microbot of the plurality of microbots, a prompt based on the user query, wherein the prompt is configured to elicit a response from a first backend domain of the plurality of backend domains;
transmit, by the first microbot, the prompt to the first backend domain;
receive, by the first microbot, a domain response from the first backend domain; and
determine, by the analytics engine, the first event tag based on the domain response.

7. The computing apparatus of claim 1, wherein the processor-executable instructions, when executed by the one or more processors, further direct the computing apparatus to:
receive a second user query from the client device via the virtual assistant application;
determine a second event tag based on the second user query, wherein the second event tag is associated with a second UI element of the plurality of UI elements;
tag the second user query with the second event tag; and
transmit, to the web analytics system, a second report comprising the second event tag, wherein the first report is transmitted to the web analytics system at a first time, the second report is transmitted to the web analytics system at a second time, and the second time is after the first time.

8. A method comprising:
receiving, by an analytics engine, a user query from a client device via a virtual assistant application hosted by a web-based application, wherein the web-based application comprises a plurality of user interface (UI) elements;
determining, by the analytics engine, a first event tag based on the user query, wherein:
each of the plurality of UI elements is assigned a respective event tag; and
the first event tag is associated with a first UI element of the plurality of UI elements;
tagging, by the analytics engine, the user query with the first event tag to associate the user query with the first UI element; and
transmitting, to a web analytics system associated with the web-based application, a first report comprising the first event tag.

9. The method of claim 8, wherein the analytics engine comprises a natural language model and determining, by the analytics engine, the first event tag based on the user query further comprises:
determining, using the natural language model, a user intent based on the user query; and
selecting, by the analytics engine, the first event tag based on the user intent.

10. The method of claim 8, wherein the method further comprises:
receiving, by the analytics engine, a second user query from the client device via the virtual assistant application;
determining, by the analytics engine, a second event tag based on the second user query, wherein the second event tag is associated with a second UI element of the plurality of UI elements;
tagging, by the analytics engine, the second user query with the second event tag to associate the second user query with the second UI; and
transmitting, to the web analytics system, a second report comprising the second event tag, wherein the first report is transmitted to the web analytics system at a first time, the second report is transmitted to the web analytics system at a second time, and the second time is after the first time.

11. The method of claim 8, wherein the first report comprises one or more of:
a timestamp associated with the user query;
the user query; or
a query response generated by the virtual assistant application responsive to the user query.

12. The method of claim 8, wherein determining, by the analytics engine, the first event tag based on the user query comprising:
determining, by the analytics engine, a query response generated responsive to the user query; and
determining, by the analytics engine, the first event tag based on the query response.

13. The method of claim 8, wherein the analytics engine comprises a plurality of microbots, wherein each of the plurality of microbots is associated with a respective backend domain within a plurality of backend domains, and the method further comprises:
generating, by a first microbot of the plurality of microbots, a prompt based on the user query and user data associated with the client device, wherein the prompt is configured to elicit a response from a first backend domain;
transmitting, by the first microbot, the prompt to the first backend domain;
receiving, by the first microbot, a domain response from the first backend domain; and
determining, by the analytics engine, the first event tag based on the domain response.

14. The method of claim 8, wherein the analytics engine comprises a plurality of microbots, wherein each of the plurality of microbots is associated with a respective backend domain within a plurality of backend domains, and the method further comprises:
determining, by the analytics engine, a user intent based on the user query; and
selecting, by the analytics engine, a first microbot of the plurality of microbots for handling the user query based on the user intent.

15. A computer-readable storage medium comprising processor-executable instructions, wherein the processor-executable instructions comprise an analytics engine configured to cause one or more processors to:
receive, from an analytics engine, a user query from a client device via a virtual assistant application hosted by a web-based application, wherein the web-based application comprises a plurality of user interface (UI) elements;
determine, by the analytics engine, a first event tag based on the user query, wherein:
each of the plurality of UI elements is assigned a respective event tag; and
the first event tag is associated with a first UI element of the plurality of UI elements;
tag, by the analytics engine, the user query with the first event tag associated with the first UI element; and
generate, by the analytics engine, a report comprising the first event tag and the user query.

16. The computer-readable storage medium of claim 15, wherein the processor-executable instructions to determine, by the analytics engine, the first event tag based on the user query cause the one or more processors to further execute processor-executable instructions stored in the computer-readable storage medium to:
determine, by the analytics engine, a user intent based on the user query;
determine, by the analytics engine, that the user intent corresponds to the first UI element; and
select, by the analytics engine, the first event tag based on the user intent corresponding to the first UI element.

17. The computer-readable storage medium of claim 15, wherein the processor-executable instructions cause the one or more processors to further execute processor-executable instructions stored in the computer-readable storage medium to:
map, by the analytics engine, the user query to the first UI element of the plurality of UI elements based on the first event tag.

18. The computer-readable storage medium of claim 15, wherein the processor-executable instructions cause the one or more processors to further execute processor-executable instructions stored in the computer-readable storage medium to:
receive, by the analytics engine, a second user query from the client device via the virtual assistant application;
determine, by the analytics engine, a second event tag based on the second user query, wherein the second event tag is associated with a second UI element of the plurality of UI elements;
tag, by the analytics engine, the second user query with the second event tag; and
transmit, by the analytics engine, the report comprising the first event tag and the second event tag to a web analytics system associated with the web-based application.

19. The computer-readable storage medium of claim 15, wherein the analytics engine comprises a plurality of microbots, each of the plurality of microbots being associated with a respective backend domain within a plurality of backend domains, and the processor-executable instructions cause the one or more processors to further execute processor-executable instructions stored in the computer-readable storage medium to:
generate, by a first microbot of the plurality of microbots, a prompt based on the user query, wherein the prompt is configured to elicit a response from a first backend domain;
transmit, by the first microbot, the prompt to the first backend domain;
receive, by the first microbot, a domain response from the first backend domain; and
determine, by the analytics engine, the first event tag based on the domain response.

20. The computer-readable storage medium of claim 15, wherein the processor-executable instructions cause the one or more processors to further execute processor-executable instructions stored in the computer-readable storage medium to:
provide, by the analytics engine, the report to a web analytics system associated with the web-based application, wherein the report generated by the analytics engine comprises one or more of:
a timestamp associated with the user query;
the user query; or
a query response generated by the virtual assistant application responsive to the user query.
